(19) United States
(12) Patent Application Publication
(10) Pub. No.: US 2005/0018372 A1
(43) Pub. Date: Jan. 27, 2005

(54) Control system for a power supply protector controllable through an IP address

(75) Inventor: Kwok-Ying Hui, New Territories (HK)

Correspondence Address: ARENT FOX KINTNER PLOTKIN & KAHN, PLLC;Suite 400, 1050 Connecticut Avenue, N.W., Washington, DC, 20036-5339, US

(73) Assignee: Rocom Electric Company Ltd.

(21) Appl. No.: 10/862,411

(22) Filed: Jun. 8, 2004

(30) Foreign Application Priority Data
Jul. 21, 2003 (TW) 92119808

(51) Int. Cl. H02H 3/20

(52) U.S. Cl. 361/90

(57) ABSTRACT

A control system for a power supply protector controllable through an IP address is provided. The control system controls the power supply protector in an indirect, effective, secure manner via executing transmission of commands via using highly identity check and highly security performance of a control gateway, with regarding to the property of a low performance microprocessor of the power supply at the rear end of the control gateway, in a web in a low security grade.

### BACKGROUND OF THE INVENTION

1. Field of the Invention

The present invention relates to a control system for a power supply protector controllable through an IP address and, more particularly, to indirect, effective, secure control over the power supply protector via executing transmission of commands via using highly identity check and highly security performance of a control gateway, with regarding to the property of a low performance microprocessor of the power supply protector at the rear end of the control gateway, in a web in a low security grade.

2. Description of the Related Art

Fast development of webs entails security problems. All data are transmitted according to Transmission Control Protocol/Internet Protocol (“TCP/IP”). In conventional communication techniques for remote control over power supplies and devices through TCP/IP, remote power supply control and remote device control are combined so as to provide a system manager with complete console port management and power supply ON/OFF control. For the system manager can set a remote console port through the Internet, a remote device controller, he or she can turn on and off a power supply connected with a remote power supply controller.

An ordinary communication server includes 8 or 16 RS232 serial ports and 10/100 Mbps network port connected with both a host and the RS-232 devices such as a terminal, a modem, a data switch, a mainframe computer and tools for communication of data between POS devices.

In the conventional method for remote control over devices, the communication of the devices with the device management system is executed through RS-232. The topology of the multiple devices is a daisy chain. No more than 64 devices can be connected. Control commands for the remote device take a direct drive manner from the device management system to the remote device. Moreover, a check on a user's identity is simply a check on the user's ID and password. The user's ID, password and commands are not encoded before transmission.

In the conventional method for remote control over devices, the devices are connected with the device management system through RS232. With RS232, the maximum connection distance is 15 meters and the maximum transmission rate is 19200 bits/s. The transmission takes place in a short distance and at a low rate. Furthermore, because the topology is a daisy chain, the maximum number of the devices that can be connected is 64. Once a device (“abnormal device”) fails, all devices after the abnormal device cannot communicate at a gateway. Moreover, a check on the user's identity is simply a check on the user's ID and password. The user's ID, password and commands are not encoded before transmission.

It is not secure to transmit the user's ID, password and commands without encoding them. Their encoding in transmission is limited because of the performance of single-chip microprocessors (4, 8 or 16 bits) of the devices.

Therefore, a control system for a power supply protector controllable through an IP address is needed for indirect, effective, secure control over the power supply protector via executing transmission of commands via using highly identity check and highly security performance of a control gateway, with regarding to the property of a low performance microprocessor of the power supply at the rear end of the control gateway, in a web in a low security grade.

### SUMMARY OF THE INVENTION

It is an objective of the present invention to provide a control system for a power supply protector controllable through an IP address so that control commands of a remote control server for a power supply protector are under control of a control gateway with an IP address.

The control gateway runs proxy software for checking a user's identity, managing layout messages of the power supply protector and the user's messages in a centralized manner, receiving the control commands from the system management system and transmitting the commands to the system based on the IP address. An encoding and decoding method of a public key RSA and a symmetric code key DES is implemented in the proxy software.

It is another objective of the present invention to provide a control system for power supply protector controllable through IP addresses so that a topology of all power supply protectors is a star-shaped topology so that every power supply protector includes a web controller and is assigned a fixed IP address and connected with a control gateway though a hub. Therefore, the power supply protectors are not limited in number. The communication of a power supply protector does not affect that of any other power supply protector.

It is another objective of the present invention to provide a control system for a power supply protector controllable through an IP address so that PKI encoding and decoding technique is used for exchange of user's registration identification messages and a conversation code key. The control system includes symmetric code keys, one public and the other private. When registering from a power supply protector control system, a user receives the public key from the proxy first. Then, the user uses the public key to encode his identification messages and transmit the same to the proxy. Then, the proxy uses the private key to decode the encoded identification messages and check the same. If the identity is legal, conversation code keys or symmetric keys are produced in a random manner and the private key is used to encode and transmit to the user. The messages encoded by means of the public key are decoded by means of the private key, and vice versa.

It is another objective of the present invention to provide a control system for a power supply protector controllable through an IP address so that the power supply protector is connected with a control gateway through an ether net (TCP/IP). Shieldable double-line connection is used. Hence, a maximum connection distance is 150 meters and the transmissions rate is 10 M bits/s.

It is another objective of the present invention to provide a control system for a power supply protector controllable through an IP address so that symmetric code key encoding is used to transmit commands so as to ensure security of communication.

It is another objective of the present invention to provide a control system for a power supply protector controllable through an IP address so that a control gateway includes a built-in filtering fire wall function so as to form a fire wall between a device subnet and an external web in order to effectively protect a controlled device against external attacks.

It is another objective of the present invention to provide a control system for a power supply protector controllable through an IP address so that a control gateway is used to ensure the security of a local ether net. The performance of a controlled device connected with the net is a controller based on a SoC single-chip microprocessor with a low performance.

According to one preferred embodiment of the present invention, a control system for a power supply protector controllable through an IP address comprises a control gateway, a power supply protector and a remote control server. The control gateway comprises a CPU, a system storage device for storing web security software, a first network Interface connected with a subnet, a second network Interface connected with an external web. The power supply protector is connected with the subnet and comprises an I/O interface. The power supply protector is based on a single-chip microprocessor for receiving commands from the control gateway and has a performance lower than that of the CPU. The remote control server is connected with the external web. Only encoded commands transmitted from the remote control server enter the control gateway and further to the power supply protector that is connected with the subnet.

Other objects, advantages and novel features of the invention will become more apparent from the following detailed description in conjunction with the attached drawings.

### BRIEF DESCRIPTION OF THE DRAWINGS

The present invention will be described via detailed illustration of embodiments referring to the drawings.

FIG. 1 is a schematic diagram of a control system for a power supply protector controllable through an IP address according to one preferred embodiment of the present invention.

FIG. 2 is a block diagram of a control gateway of the control system of the preferred embodiment.

FIG. 3 is an architecture of the control system of the preferred embodiment.

### DETAILED DESCRIPTION OF THE PREFERRED EMBODIMENT

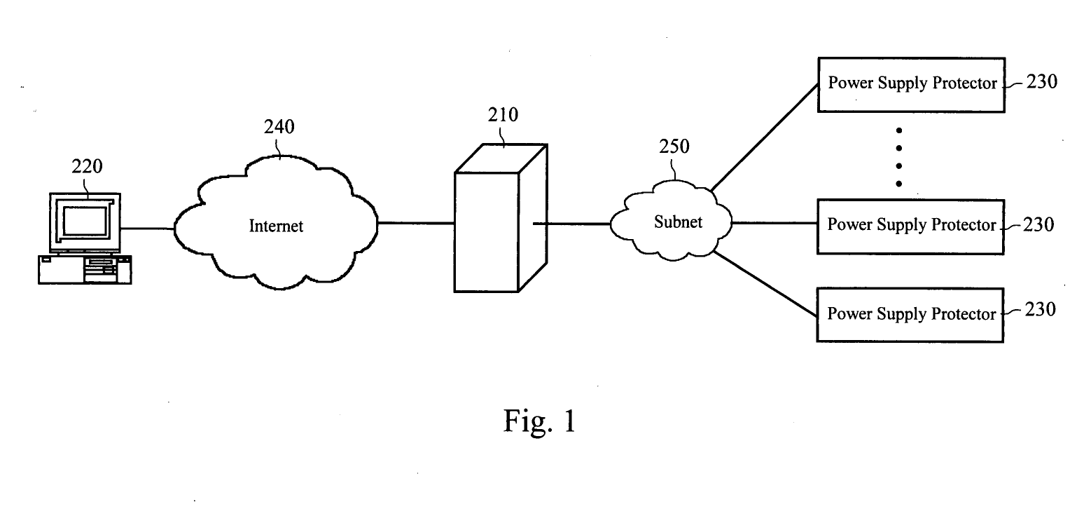

FIG. 1 shows a control system for power supply protectors controllable through IP addresses according to the preferred embodiment of the present invention. Referring to FIG. 1, the control system for power supply protectors controllable through IP addresses includes a control gateway 210 connected between the Internet 240 and a subnet 250 for processing the security of the subnet 250, a plurality of power supply protectors 230 communicated with the control gateway 210 through the subnet 250 and a remote control server 220 for sending encoded commands to the control gateway 210 and monitoring the power supply protectors 230 through the control gateway 210 for decoding the encoded commands.

In the preferred embodiment, the control gateway 210 is used to filter the encoded commands of the remote management server 220 and decode the encoded commands based on a code key to corresponding to the encoded commands. Each power supply protector 230 connected with the subnet 250 is a controller based on a single-chip microprocessor and receives the encoded commands from the control gateway 210. The single-chip microprocessor includes a performance of 4, 8 or 16 bits. The subnet 250 is connected with a topology, a star-shaped topology. The remote control server 220 is communicated with the control gateway 210 through the Internet 240. Only the encoded commands transmitted from the remote control server 220 enter the subnet 250 through the control gateway 210 in order to control the power supply protectors 230 connected with the subnet 250.

The control gateway 210 can filter and protect messages of the other devices in the subnet 250.

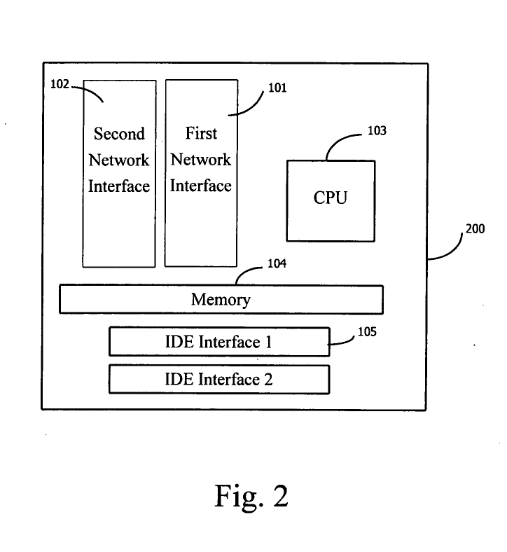

FIG. 2 is a block diagram of the control gateway 210 of the control system for power supply protectors controllable through IP addresses. Referring to FIG. 2 and further to FIG. 1, the control gateway 21 includes a central processing unit (“CPU”) 103. The performance of the CPU 103 is higher than that of the single-chip microprocessors of the power supply protectors 230. A system storage device (not shown) is used to store net security software. The CPU 103 executes the web security software so that the control gateway 210 deals with the security of the subnet 250. Thus, the control gateway 210 receives the encoded commands from the remote management server 220 through the Internet 240 and decodes the same and sends the commands to the power supply protectors 230. Moreover, the control gateway 210 includes a first network Interface 101 connected with the subnet 250 and a second network Interface 102 connected with the Internet 240.

Still referring to FIG. 2, in the preferred embodiment of the present invention, the gateway 210 is a personal computer motherboard based on Intel 80×86 (80386, 80486, Pentium). The first network Interface 101 and the second network Interface 102 are plugged in two ether net cards, respectively so as to deal with secure exchange of messages between the subnet 250 and the Internet 240. The CPU 103 is a high-level CPU. The memory 104 is a random access memory (“RAM”) of at least 16 M bytes.

A 16 M disk on module (“DOM”) is installed on an IDE interface 105 in order to store software for handling web security in the control gateway 210, including a power supply protector representing serving function and an encoding function.

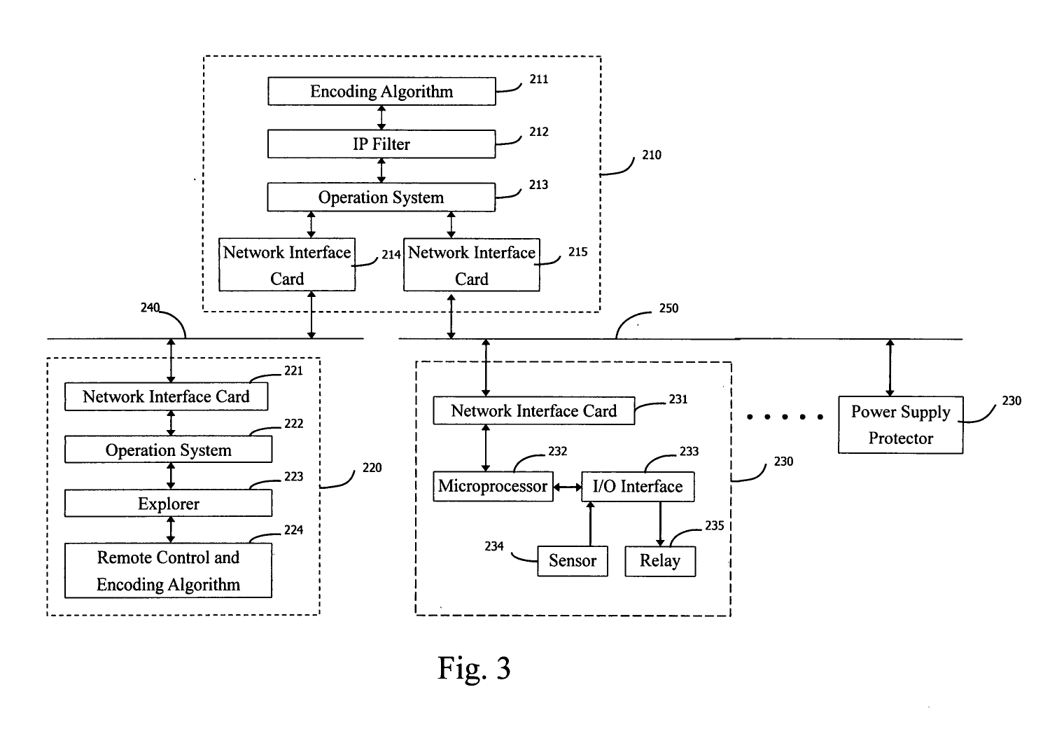

FIG. 3 shows an architecture of the control system for power supply protectors controllable through IP addresses of the preferred embodiment. Referring to FIG. 3 and further referring to FIGS. 1 and 2, the remote management server 220 is connected with the Internet 240 that supports TCP/IP. The control gateway 210 is connected with the Internet 240 through a web card 214. The control gateway 210 is connected with the subnet 250 through a web card 215. The control gateway 210 is connected with the power supply protectors 230 through the web card 215 or alternatively a connector (for connection with up to 255 devices) is provided between them.

A user can control the power supply protectors 230 through sending commands by means of the remote management server 220. Messages transmitted from or to the remote management server 220 are executed by means of the control gateway 210. In the form of TCP/IP packages, under control of operation systems 213 and 222, they are sent to the Internet 240 through a web card 221, or sent to the Internet 240 from the power supply protectors 230.

Therefore, through the Internet 240, the control gateway 210 receives commands from the remote management server 220 or various messages sent to the remote management server 220. Various messages sent to the web card 214 of the control gateway 210 must be filtered by means of the IP filter 212 regarding the source, the intended address and the portal before they are sent from the web card 214. Otherwise, messages are blocked by means of the web card 214 so that attacks are blocked.

Moreover, the IP packages that conform to the rules of the IP filter 212 are encoded and decoded. The control gateway 210 receives various control commands from the remote management server 220. If the control commands are for controlling the power supply protector 230, then they are sent to the control gateway 210 through the web card 21. The control gateway 210 decodes the control commands and sends the same to the power supply protectors 230. Then, the control gateway 210 waits for returning messages from the power supply protectors 230 and calls back the remote management server 220.

The power supply protectors 230 receive various control commands from the web card 231 through the control gateway 210. Through the single-chip microprocessor 232, the power supply protectors 230 deal with and control an I/O interface 233 of the device. Furthermore, the power supply protectors 230 feed various messages back to the remote control server 220 through the web card 231.

Encoding algorithms that are used in the control gateway 210 and the remote control server 220 are PSA PKI and DES. Remote control program and encoding algorithm 224 used in the remote control server 220 is an ActiveX control element embedded in an IE explorer 223. The first time when the explorer 223 visits the IP address of the control gateway 210, this ActiveX control element residing in a Mini Web Server 213 of the control gateway 223 is automatically downloaded to the remote management server 220.

Through a TCP/IP web, the control system of the present invention controls power supply protectors that protect against excessive voltage and overload. Furthermore, each power supply protector includes a relay 235 for controlling power supply sockets and/or a sensor 234 for detecting voltage and current.

The present invention has been described via detailed illustration of some embodiments. Those skilled in the art can derive variations from the embodiments without departing from the scope of the present invention. Therefore, the embodiments shall not limit the scope of the present invention defined in the claims.

1. A control system for a power supply protector controllable through an IP address, the control system comprising:
a control gateway comprising a CPU, a system storage device for storing web security software, a first network Interface connected with a subnet and a second network Interface connected with an external web;
a power supply protector connected with the subnet, the power supply protector comprising an I/O interface, wherein the power supply protector is based on a single-chip microprocessor for receiving commands from the control gateway, the single-chip microprocessor having a performance lower than that of the CPU; and
a remote management server connected with the external web, only encoded commands transmitted from the remote management server entering the control gateway and further to the power supply protector that is connected with the subnet.

2. The control system according to claim 1, wherein the system storage device is a Disk on Module (DOM).

3. The control system according to claim 1, wherein the first network Interface and the second network Interface are both web cards.

4. The control system according to claim 1, wherein the external web is a TCP/IP web.

5. The control system according to claim 1, wherein the power supply protector comprises a relay for controlling a power supply socket.

6. The control system according to claim 1, wherein the power supply protector comprises a sensor for monitoring voltage.

7. The control system according to claim 1, wherein the power supply protector comprises a sensor for monitoring current.

8. A control system for power supply protectors controllable through IP addresses, the control system comprising:
a control gateway comprising a system storage device for storing web security software, a first network Interface connected with a subnet, a second network Interface connected with an external web, wherein the control gateway is based on a CPU for executing the web security software in order to receive encoded commands from the Internet and transmits the commands to the subnet; and
at least one power supply protector connected with the subnet, wherein the power supply protector is based on a single-chip microprocessor for receiving commands from the control gateway, and the single-chip microprocessor having a performance lower than that of the CPU.

9. A control system for power supply protectors controllable through IP addresses, the control system comprising:
a control gateway comprising a system storage device for storing web security software, a first network Interface connected with a subnet, a second network Interface connected with an external web, wherein the control gateway is based on a CPU for executing the web security software in order to receive encoded commands from the Internet and transmits the commands to the subnet; and
a plurality of power supply protectors connected with the subnet in a topology, wherein each of the power supply protectors is based on a single-chip microprocessor for receiving commands from the control gateway, and the single-chip microprocessor having a performance of decoding lower than that of the CPU.
